(19) United States
(12) Patent Application Publication
(10) Pub. No.: US 2026/0328042 A1
(43) Pub. Date: Oct. 22, 2026

(54) A DOOR CONTROL SYSTEM AND METHOD FOR SAFE CONFIGURATION OF THE OPERATION OF A DOOR

(71) Applicant: Assa Abloy Entrance Systems AB, Landskrona (SE)

(72) Inventor: Roger DREYER, Bjarred (SE)

(21) Appl. No.: 19/485,886

(22) PCT Filed: May 17, 2024
(86) PCT No.: PCT/EP2024/063762

§ 371 Date: Nov. 19, 2025

(30) Foreign Application Priority Data
Jun. 1, 2023 (SE) 2330248-2

(51) Int. Cl. E05F 15/70; G05B 19/042

(52) U.S. Cl. CPC E05F 15/70; G05B 19/0428; E05Y 2400/456; E05Y 2400/66; E05Y 2900/132; G05B 2219/2628

(57) ABSTRACT

The disclosure relates to method and a door control system (100) for safe configuration of the operation of a door (1). The system (100) comprises: a door control unit (30) configured to operate the door (1) and configured to manage parameter settings related to the operation of the door (1); a processing circuitry (102a, 102b, 102c) operatively connected to the door control unit (30) configured to: obtain information indicative of allowable parameter setting (apm1,apm2,apm3) defining the possible parameters for operation of the door (1); receive, at the door control unit (30), a first parameter settings message indicative of updated parameter settings (pm1,pm2,pm3) related to the operation of the door (1); receive, at the door control unit (30), a second parameter settings message indicative of updated parameter settings (pm1,pm2,pm3) related to the operation of the door (1); determine if the parameter settings related to the operation of the door (1) is to be updated in view of the obtained allowable parameter setting (apm1,apm2,apm3), in that in a determination that the first parameter settings message and the second parameter settings message are both indicative of the same updated parameter settings (pm1,pm2,pm3), and allowable in view of the allowable parameter setting (apm1,apm2,apm3), update, by the door control unit (30), the parameter settings (pm1,pm2,pm3) related to the operation of the door (1).

### TECHNICAL FIELD

The present disclosure relates to a door control system for safe configuration of the operation of a door, a method for safe configuration of the operation of a door and a computer program product. More specifically, the disclosure relates to a door control system for safe configuration of the operation of a door, a method for safe configuration of the operation of a door and a computer program product as defined in the introductory parts of the independent claims.

### BACKGROUND ART

Today entrance systems managing the opening and closing an entrance, e.g. doors, are operated according to parameter settings defining e.g. the door opening time and the door opening angle etc., using parameter settings of the door when installing the door.

The operation of the door can e.g. be optimized for making it comfortable for a person to pass through the door, meaning e.g. that the door opening time, and the door opening angle are long and wide enough to not disturb the person passing the door.

It would however be desirable to control the parameters depending on different circumstances. If e.g. it is desired to save energy of the building, where the door is the entrance to the building, it may be desired to reduce the need for heating or cooling of the building. Then it may not always be desired to let the door be open too long or too wide.

Dependent on the indoor and outdoor temperature, it could of course also be the other way around, that is desired to prolong the opening time and keep the door wide open.

### SUMMARY

There is a desire to be able to dynamically change the parameter settings defining the operation of the door.

There is also a desire to keep the operation of the door safe. A false parameter setting could be harmful to the door and to the surrounding of the door. There is a desire to change the parameter setting in a safe way.

It is an object of the present disclosure to mitigate, alleviate or eliminate one or more of the above-identified deficiencies and disadvantages in the prior art and solve at least the above mentioned problem.

According to a first aspect there is provided a door control system for safe configuration of the operation of a door.

The system comprises a door control unit configured to operate the door and configured to manage parameter settings related to the operation of the door, and a processing circuitry operatively connected to the door control unit.

The processing circuitry is configured to obtain information indicative of allowable parameter setting defining the possible parameters for operation of the door, receive, at the door control unit, a first parameter settings message indicative of updated parameter settings related to the operation of the door, and receive, at the door control unit, a second parameter settings message indicative of updated parameter settings related to the operation of the door.

The processing circuitry is further configured to determine if the parameter settings related to the operation of the door is to be updated in view of the obtained allowable parameter setting, in that in a determination that the first parameter settings message and the second parameter settings message are both indicative of the same updated parameter settings, and allowable in view of the allowable parameter setting, update, by the door control unit, the parameter settings related to the operation of the door.

Further, in a determination that the first parameter settings message and the second parameter settings message are indicative of different updated parameter settings or not allowable in view of the allowable parameter setting, ignore updating the parameter settings related to the operation of the door.

An advantage with the first aspect is that the parameter settings can be updated in a controlled and reliable way, to enable dynamic operation of the door according to the updated parameter settings, in that the received updated parameter settings is an allowable parameter setting, but also in that the updated parameter settings are received twice, eliminating possible false update of the parameter settings due to a possible damaged message, by the verification of the received parameter settings of the first and second parameter settings message.

According to some embodiments the system further comprises a user interface configured to receive input if a user, wherein the user interface is operatively connected to the door control unit and the processing circuitry, and wherein processing circuitry is further configured to obtain information indicative of allowable parameter setting defining the possible parameters for operation of the door by receiving input from a user via the user interface.

An advantage with this embodiment is that e.g. a person installing the door can input allowable parameter setting defining the possible parameters for operation of the door via the user interface in order to adapt the default values set when manufacturing the door for operation of the door according to the environment where the door is installed.

According to some embodiments the system further comprises a door operator terminal configured to be operated by a user and configured to communicate with the door control unit, and wherein the door operator terminal is operatively connected to the door control unit and the processing circuitry.

An advantage with this embodiment is that the parameter settings of the door can be remotely managed via the door operator terminal reducing the need for a person to be present at the door in order to update the parameter settings.

According to some embodiments, the processing circuitry is further configured to send, from the door control unit to the door operator terminal an allowable parameter settings message indicative of allowable parameter setting defining the possible parameters for operation of the door, and enable the door operator terminal to only send allowable updated parameter settings from the door control unit to the door operator terminal.

An advantage with this embodiment is that the door operator terminal becomes aware of the parameter settings that are possible in view of the allowable parameter setting, and by hindering the door operator terminal to send other parameter settings that are outside of the allowable parameter setting, minimizes the risk of that a false parameter setting is sent to the door control unit from the door operator terminal.

According to some embodiments the processing circuitry is further configured to send, from the door operator terminal to the door control unit, a first parameter settings message indicative of updated parameter settings related to the operation of the door, and send, from the door operator terminal to the door control unit, a second parameter settings message indicative of updated parameter settings related to the operation of the door.

An advantage with this embodiment is that the door operator terminal is configured to send two separate messages in order to establish that the updated parameter settings as indicated in the first message, truly are correct by sending a second message with the same update parameter settings in order to enable that the desired updated parameter settings are correctly received at the door control unit.

According to some embodiments, the processing circuitry is further configured to receive, at the door control unit, a machine-to-machine command setting message indicative of a set value for operating the door, and in a determination that the set value is allowable in view of the current parameter setting, allow operation of the door according to the received machine-to-machine command setting message, and in a determination that the set value is not allowable in view of the current parameter setting, ignore operation of the door according to the received machine-to-machine command setting message.

An advantage with this embodiment is that one machine-to-machine command setting message generated and sent by a machine to the door control unit, in order to control the operation of the door, can be received and change the operation of the door according to the set value in the case that the received machine-to-machine command setting message is indicative of a set value that is an allowable value when comparing the set value with the current parameter setting.

According to some embodiments, if the second parameter settings message is not received within a first predetermined threshold time period after receiving the first parameter settings message, ignore updating the parameter settings related to the operation of the door. An advantage with this embodiment is that the parameter setting can only be updated in the case that the second parameter settings message is received within the first predetermined threshold time period after receiving the first parameter settings message, meaning that one parameter settings message is not sufficient enough for updating the parameter settings.

According to some embodiments, if the second parameter settings message is received after a second predetermined threshold time period after receiving the first parameter settings message, ignore updating the parameter settings related to the operation of the door and make the received second parameter settings message a first parameter settings message and await a further parameter settings message within the first predetermined threshold time period to be considered as a second parameter settings message.

An advantage with this embodiment is that in the case that a further parameter settings message is received within the first predetermined threshold time period then two messages are received, enabling updating of the parameter settings related to the operation of the door.

According to a second aspect there is provided a method for safe configuration of the operation of a door. The method comprising the step of obtaining allowable parameter setting defining the possible parameters for operation of the door, the step of receiving, at a door control unit, a first parameter settings message indicative of updated parameter settings related to the operation of the door, and the step of receiving, at the door control unit, a second parameter settings message indicative of updated parameter settings related to the operation of the door.

The method further comprising the step of determining if the parameter settings related to the operation of the door is to be updated in view of the obtained allowable parameter setting, in that in a determination that the first parameter settings message and the second parameter settings message are both indicative of the same updated parameter settings, and allowable in view of the allowable parameter setting, update, by the door control unit, the parameter setting related to the operation of the door. The method further comprising that in a determination that the first parameter settings message and the second parameter settings message are indicative of different updated parameter settings or not allowable in view of the allowable parameter setting, ignore updating the parameter settings related to the operation of the door.

An advantage with the second aspect is that the parameter settings can be updated in a controlled and reliable way, to enable dynamic operation of the door according to the updated parameter settings, in that the received updated parameter settings is an allowable parameter setting, but also in that the updated parameter settings are received twice, eliminating possible false update of the parameter settings due to a possible damaged message, by the verification of the received parameter settings of the first and second parameter settings message.

According to some embodiments, the method comprises the step of obtaining information indicative of allowable parameter setting defining the possible parameters for operation of the door by receiving input from a user via the user interface.

An advantage with this embodiment is that e.g. a person installing the door can input allowable parameter setting defining the possible parameters for operation of the door via the user interface in order to adapt the default values set when manufacturing the door for operation of the door according to the environment where the door is installed.

According to some embodiments, the method further comprises the step of sending, from the door control unit to a door operator terminal an allowable parameter setting message indicative of allowable parameter setting defining the possible parameters for operation of the door, and the step of enabling the door operator terminal to only send allowable updated parameter settings from the door control unit to the door operator terminal.

An advantage with this embodiment is that the door operator terminal becomes aware of the range of parameter settings that are possible in view of the allowable parameter setting, and by hindering the door operator terminal to send other parameter settings that are outside of the allowable parameter setting, minimizes the risk of that a false parameter setting is sent to the door control unit from the door operator terminal.

According to some embodiments, the method further comprises the step of sending, from the door operator terminal to the door control unit, a first parameter settings message indicative of updated parameter settings related to the operation of the door, and the step of sending, from the door operator terminal to the door control unit, a second parameter settings message indicative of updated parameter settings related to the operation of the door.

An advantage with this embodiment is that the door operator terminal is configured to send two separate messages in order to establish that the updated parameter settings as indicated in the first message, truly are correct by sending a second message with the same update parameter settings in order to enable that the desired updated parameter settings are correctly received at the door control unit.

According to some embodiments, if the second parameter settings message is not received within a first predetermined threshold time period after receiving the first parameter settings message, ignore updating the parameter settings related to the operation of the door. An advantage with this embodiment is that the parameter setting can only be updated in the case that the second parameter settings message is received within the first predetermined threshold time period after receiving the first parameter settings message, meaning that one parameter settings message is not sufficient enough for updating the parameter settings.

According to some embodiments, the method further comprises the step of receiving, at the door control unit, a machine-to-machine command setting message indicative of a set value for operating the door, and in a determination that the set value is allowable in view of the current parameter setting then allow operation of the door according to the received machine-to-machine command setting message, and in a determination that the set value is not allowable in view of the current parameter setting then ignore operation of the door according to the received machine-to-machine command setting message.

An advantage with this embodiment is that one machine-to-machine command setting message generated and sent by a machine to the door control unit, in order to control the operation of the door, can be received and change the operation of the door according to the set value in the case that the received machine-to-machine command setting message is indicative of a set value that is an allowable value when comparing the set value with the current parameter setting.

According to a third aspect there is provided a computer program product comprising a non-transitory computer readable medium, having thereon a computer program comprising program instructions, the computer program being loadable into a processing circuitry and configured to cause execution of the method according to the second aspect when the computer program is run by the processing circuitry.

Effects and features of the second and third aspects are to a large extent analogous to those described above in connection with the first aspect. Embodiments mentioned in relation to the first aspect are largely compatible with the second and third aspects.

The present disclosure will become apparent from the detailed description given below. The detailed description and specific examples disclose preferred embodiments of the disclosure by way of illustration only. Those skilled in the art understand from guidance in the detailed description that changes and modifications may be made within the scope of the disclosure.

Hence, it is to be understood that the herein disclosed disclosure is not limited to the particular component parts of the device described or steps of the methods described since such device and method may vary. It is also to be understood that the terminology used herein is for purpose of describing particular embodiments only, and is not intended to be limiting. It should be noted that, as used in the specification and the appended claim, the articles “a”, “an”, “the”, and “said” are intended to mean that there are one or more of the elements unless the context explicitly dictates otherwise. Thus, for example, reference to “a unit” or “the unit” may include several devices, and the like. Furthermore, the words “comprising”, “including”, “containing” and similar wordings does not exclude other elements or steps.

### BRIEF DESCRIPTIONS OF THE DRAWINGS

The above objects, as well as additional objects, features and advantages of the present disclosure, will be more fully appreciated by reference to the following illustrative and non-limiting detailed description of example embodiments of the present disclosure, when taken in conjunction with the accompanying drawings.

FIG. 1a illustrates a door control system for safe configuration of the operation of a door according to an embodiment of the present disclosure, illustrated with a swing door as the door and a smartphone as a door operator terminal.

FIG. 1b illustrates a door control system for safe configuration of the operation of a door according to an embodiment of the present disclosure, illustrated with an overhead sectional door as the door and a computer as a door operator terminal.

FIG. 2 illustrates a flow chart of the method steps according to the second aspect of the disclosure.

FIG. 3 illustrates a computer program product according to the third aspect of the disclosure.

FIG. 4 illustrates example flow chart of the method steps in relation to the messaging between the door operator terminal, the door control unit and a machine, according to some embodiments of the present disclosure.

FIG. 5a illustrates an example flow chart of a successful update of parameter settings.

FIG. 5b illustrates an example flow chart of a successful and unsuccessful update of parameter settings.

### DETAILED DESCRIPTION

The present disclosure will now be described with reference to the accompanying drawings, in which preferred example embodiments of the disclosure are shown. The disclosure may, however, be embodied in other forms and should not be construed as limited to the herein disclosed embodiments. The disclosed embodiments are provided to fully convey the scope of the disclosure to the skilled person.

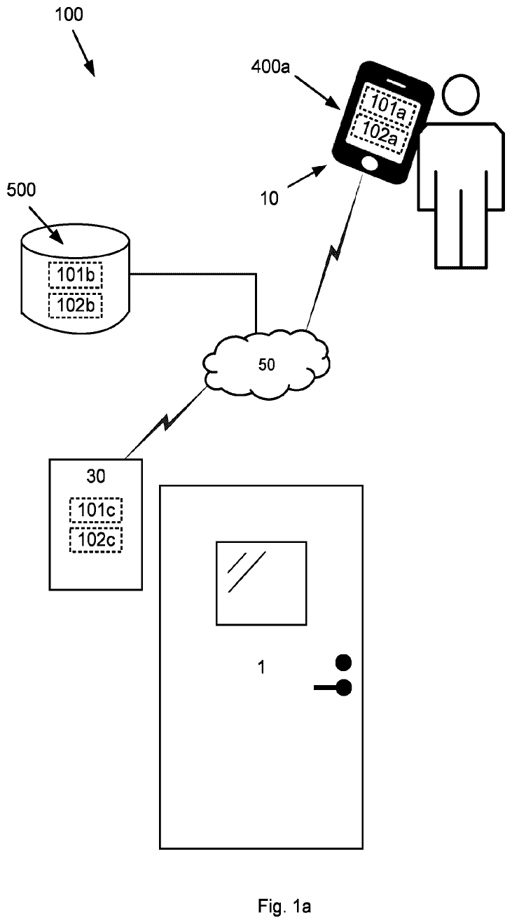

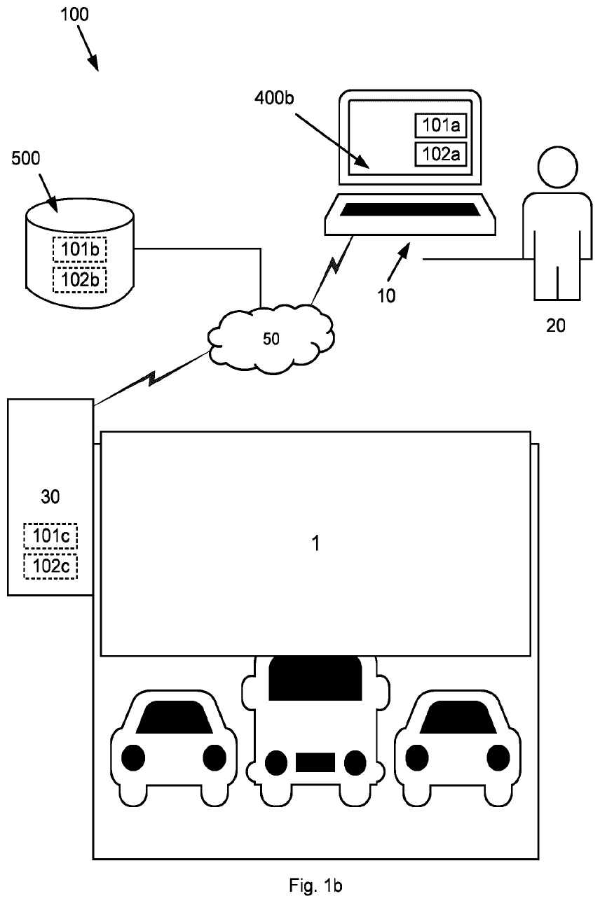

FIG. 1a illustrates a door control system 100 for safe configuration of the operation of a door 1 according to an embodiment of the present disclosure.

The first aspect of this disclosure shows a door control system 100 for safe configuration of the operation of a door 1. According to some embodiments, the door 1 is any of an overhead sectional door, a folding door, a vertical-lifting door, a high speed door, a garage door, a mega door revolving door, a slider door, a hangar door, a sliding door and a swing door. In further example embodiments the door 1 is any entrance shield. According to some embodiments, the door 1 is any of a roller shutter, a shield and a road block. In the FIG. 1a the door 1 is illustrated as a swing door.

The system 100 comprises a door control unit 30 configured to operate the door 1 and configured to manage parameter settings related to the operation of the door 1. In the FIGS. 1a and 1b the door operator control unit 30 is arranged in the vicinity of the door 1. According to some embodiments the door operator control unit 30 is configured to steer and/or control operation of movement of the door 1. According to some embodiments the door operator control unit 30 is configured to operate a door operator device of the door 1 wherein in the door operator device is configured to cause a movement of the door 1. According to some embodiments the door operator device is any of an electrical motor, a compressor, a pneumatic device or a hydraulic device.

The system 100 further comprises a processing circuitry 102a, 102b,102c operatively connected to the door control unit 30. According to some embodiments the processing circuitry 102a is comprised in a door operator terminal 10. According to some embodiments, the processing circuitry 102b is comprised in a remote device 500 that is a stationary electronic device. According to some embodiments the processing circuitry 102c is arranged at the door operator control unit 30 at the door 1.

According to some embodiments the system 100 further comprises a memory 101a, 101b,101c operatively connected to the door operator terminal 10, the door operator control unit 30 and the processing circuitry 102a,102b,102c.

According to some embodiments the memory 101a is comprised in the door operator terminal 10. According to some embodiments, the memory 101b is comprised in a remote device 500 that is a stationary electronic device. According to some embodiments the memory 101c is arranged at the door operator control unit 30 at the door 1.

According to some embodiments the processing circuitry 102a,102b,102c, the door operator terminal 10 and the door operator control unit 30 are operatively connected via a communication network 50 as illustrated in the FIGS. 1a and 1b.

According to some embodiments the communication network 50 is a wireless communication network.

According to some embodiments the wireless communication network is a standardized wireless local area network such as a Wireless Local Area Network, WLAN, Bluetooth™, ZigBee, Ultra-Wideband, UWB, Radio Frequency Identification, RFID, or similar network.

According to some embodiments the wireless communication network is a standardized wireless wide area network such as a Global System for Mobile Communications, GSM, Extended GSM, General Packet Radio Service, GPRS, Enhanced Data Rates for GSM Evolution, EDGE, Wideband Code Division Multiple Access, WCDMA, Long Term Evolution, LTE, Narrowband-IoT, 5G, Worldwide Interoperability for Microwave Access, WiMAX or Ultra Mobile Broadband, UMB or similar network.

According to some embodiments the wireless communication network can also be a combination of both a wireless local area network and a wireless wide area network.

According to some embodiments communication network 50 can be a combination a wired communication network and a wireless communication network. According to some embodiments the communication network 50 is defined by common Internet Protocols.

The processing circuitry 102a,102b,102c is configured to obtain information indicative of allowable parameter setting apm1,apm2,apm3 defining the possible parameters for operation of the door 1.

According to some embodiments the information indicative of allowable parameter setting apm1, apm2, apm3 is indicative of a range of allowable parameter settings. According to some embodiments an allowable parameter setting is a value within a range of allowable values. In an example an allowable parameter setting is the value “4” within the range of allowable values 1-10.

According to some embodiments the information indicative of allowable parameter setting apm1, apm2, apm3 is indicative of different values as allowable parameter settings.

According to some embodiments an allowable parameter setting is a value of plural allowable values. In an example an allowable parameter setting is the value “4” of allowable values 2, 4, 6, 8, 10.

According to some embodiments the information indicative of allowable parameter setting apm1, apm2, apm3 is indicative of a value above or below a predefined threshold value as allowable parameter settings. According to some embodiments an allowable parameter setting is a value above a predefined threshold value. In an example an allowable parameter setting is the value “4” of allowable values above the threshold value “2”.

According to some embodiments an allowable parameter setting is a value below a predefined threshold value. In an example an allowable parameter setting is the value “4” of allowable values below the threshold value “8”.

According to some embodiments the information indicative of allowable parameter setting apm1, apm2, apm3 is obtained by the door control unit 30 and comprising parameter default values set when manufacturing the door 1.

According to some embodiments the information indicative of allowable parameter setting apm1, apm2, apm3 is obtained from a remote stationary device 500, such as a server, comprising parameter default values set when manufacturing the door 1.

According to some embodiments the information indicative of allowable parameter setting apm1, apm2, apm3 is obtained from the door control unit 30, comprising parameter default values set when manufacturing the door 1.

According to some embodiments the information indicative of allowable parameter setting apm1, apm2, apm3 is obtained from an external device, such as a tool, comprising parameter default values set when manufacturing the door 1.

According to some embodiments the information indicative of allowable parameter setting apm1, apm2, apm3 is set when manufacturing the door and is then updated by a person when installing the door. In an example an allowable parameter setting related to the opening angle of the door can be set to one value when manufacturing the door 1, but then updated to another value by a person when installing the door 1 in order to be adapted to the environment where the door 1 is installed.

The processing circuitry 102a, 102b,102c is further configured to receive, at the door control unit 30, a first parameter settings message indicative of updated parameter settings pm1,pm2,pm3 related to the operation of the door 1, receive, at the door control unit 30, a second parameter settings message indicative of updated parameter settings pm1,pm2,pm3 related to the operation of the door 1, determine if the parameter settings related to the operation of the door 1 is to be updated in view of the obtained allowable parameter setting apm1,apm2,apm3, in that in a determination that the first parameter settings message and the second parameter settings message are both indicative of the same updated parameter settings pm1,pm2,pm3, and allowable in view of the allowable parameter setting apm1,apm2,apm3, update, by the door control unit 30, the parameter settings pm1,pm2,pm3 related to the operation of the door 1, and in a determination that the first parameter settings message and the second parameter settings message are indicative of different updated parameter settings or not allowable in view of the allowable parameter setting apm1,apm2,apm3, ignore updating the parameter settings related to the operation of the door 1.

An advantage with the first aspect is that the parameter settings can be updated in a controlled and reliable way, to enable dynamic operation of the door 1 according to the updated parameter settings, in that the received updated parameter settings is an allowable parameter setting, but also in that the updated parameter settings are received twice, eliminating possible false update of the parameter settings due to a possible damaged message, by the verification of the received parameter settings of the first and second parameter settings message.

According to some embodiments the system 100 further comprises a user interface 400a,400b configured to receive input if a user 20. According to some embodiments the user interface 400a, 400b is a user interface of any of the door control unit 30, the door operator terminal 10 and a remote terminal.

The user 20 is typically an authorized and/or trained service technician that e.g. installs the door 1 and that may need to update the default values set when manufacturing the door due to the environment that the door 1 is installed in to ensure safe operation of the door 1. In an example, the default allowable range value for the opening angle of the door 1 when manufacturing the door is set to 0 -180 degrees, but when installing the door 1 the allowable range value must be restricted to 0 -120 degrees.

The user interface 400a,400b is operatively connected to the door control unit 30 and the processing circuitry 102a,102b,102c, wherein processing circuitry 102a, 102b,102c is further configured to obtain information indicative of allowable parameter setting apm1,apm2,apm3 defining the possible parameters for operation of the door 1 by receiving input from a user 20 via the user interface 400a,400b.

An advantage with this embodiment is that e.g. a person installing the door 1 can input allowable parameter setting defining the possible parameters for operation of the door 1 via the user interface 400a,400b in order to adapt the default values set when manufacturing the door 1 for operation of the door according to the environment where the door is installed.

According to some embodiments the system 100 further comprises a door operator terminal 10 configured to be operated by a user 20 and configured to communicate with the door control unit 30, and wherein the door operator terminal 10 is operatively connected to the door control unit 30 and the processing circuitry 102a, 102b,102c.

An advantage with this embodiment is that the parameter settings of the door can be remotely managed via the door operator terminal reducing the need for a person to be present at the door in order to update the parameter settings.

According to some embodiments the processing circuitry 102a,102b,102c is further configured to send, from the door control unit 30 to the door operator terminal 10 an allowable parameter settings message indicative of allowable parameter setting apm1,apm2,apm3 defining the possible parameters for operation of the door 1, and enable the door operator terminal 10 to only send allowable updated parameter settings from the door control unit 30 to the door operator terminal 10.

An advantage with this embodiment is that the door operator terminal 10 becomes aware of the parameter settings that are possible in view of the allowable parameter setting, and by hindering the door operator terminal 10 to send other parameter settings that are outside of the allowable parameter setting, minimizes the risk of that a false parameter setting is sent to the door control unit 30 from the door operator terminal 10.

According to some embodiments the processing circuitry 102a,102b,102c is further configured to send, from the door operator terminal 10 to the door control unit 30, a first parameter settings message indicative of updated parameter settings pm1,pm2,pm3 related to the operation of the door 1, and send, from the door operator terminal 10 to the door control unit 30, a second parameter settings message indicative of updated parameter settings pm1,pm2,pm3 related to the operation of the door 1.

An advantage with this embodiment is that the door operator terminal 10 is configured to send two separate messages in order to establish that the updated parameter settings as indicated in the first message, truly are correct by sending a second message with the same update parameter settings in order to enable that the desired updated parameter settings are correctly received at the door control unit.

According to some embodiments the processing circuitry 102a,102b,102c is further configured to receive, at the door control unit 30, a machine-to-machine command setting message indicative of a set value for operating the door 1, and in a determination that the set value is allowable in view of the current parameter setting pm1,pm2,pm3, allow operation of the door 1 according to the received machine-to-machine command setting message, and in a determination that the set value is not allowable in view of the current parameter setting pm1,pm2,pm3, ignore operation of the door 1 according to the received machine-to-machine command setting message.

According to some embodiments the machine-to-machine command setting message comprises a command indicative of operation of the door according to at least a first value of a parameter setting. In an example the machine-to-machine command setting message comprises a command indicative of a parameter setting value related to the door opening time. In the example the machine-to-machine command setting message comprises a value related to the door opening time 15 seconds and the current parameter setting allows a value range of 1-7200 seconds. In the example the value related to the door opening time 15 seconds is hence allowable, and the operation of the door will be set accordingly. Hence if the value related to the door opening time would have been 14400 seconds, it would not been allowable in view of the current parameter setting range of 1-7200 seconds, and hence the operation of the door would not be set accordingly.

An advantage with this embodiment is that one machine-to-machine command setting message generated and sent by a machine 900 to the door control unit 30, in order to control the operation of the door 1, can be received and change the operation of the door 1 according to the set value in the case that the received machine-to-machine command setting message is indicative of a set value that is an allowable value when comparing the set value with the current parameter setting.

According to some embodiments the updated parameter settings are communicated back to the machine 900 sending the machine-to-machine command setting message confirming the updated parameter settings. In the above example the value 15 seconds is communicated back to the machine 900 sending the machine-to-machine command setting message.

According to some embodiments in a determination that the set value of the machine-to-machine command setting message is not allowable in view of the current parameter setting apm1,apm2,apm3, operate the door 1 according to the closest allowable parameter setting apm1,apm2,apm3 in view of the set value of the received machine-to-machine command setting message. In an example the machine-to-machine command setting message comprises a command indicative of a parameter setting value related to the door opening time and the current parameter setting allows a value range of 1-7200 seconds. In the example of that the set value of the machine-to-machine command setting message is 14400 seconds, the set value is not allowable in view of the current parameter setting range of 1-7200 seconds, however in the example the door is operated according to the closest current parameter setting which is 7200 seconds.

According to some embodiments the updated parameter settings are communicated back to the machine 900 sending the machine-to-machine command setting message confirming the updated parameter settings. In the example the value 7200 seconds is communicated back to the machine 900 sending the machine-to-machine command setting message.

According to some embodiments the second parameter settings message is not received within a first predetermined threshold time period after receiving the first parameter settings message, ignore updating the parameter settings related to the operation of the door 1.

An advantage with this embodiment is that the parameter setting can only be updated in the case that the second parameter settings message is received within the first predetermined threshold time period after receiving the first parameter settings message, meaning that one parameter settings message is not sufficient enough for updating the parameter settings.

According to some embodiments, if the second parameter settings message is received after a second predetermined threshold time period after receiving the first parameter settings message, ignore updating the parameter settings related to the operation of the door 1 and make the received second parameter settings message a first parameter settings message and await a further parameter settings message within the first predetermined threshold time period to be considered as a second parameter settings message.

An advantage with this embodiment is that in the case that a further parameter settings message is received within the first predetermined threshold time period, then two messages are received, enabling updating of the parameter settings related to the operation of the door.

The second aspect of this disclosure shows a method for safe configuration of the operation of a door 1.

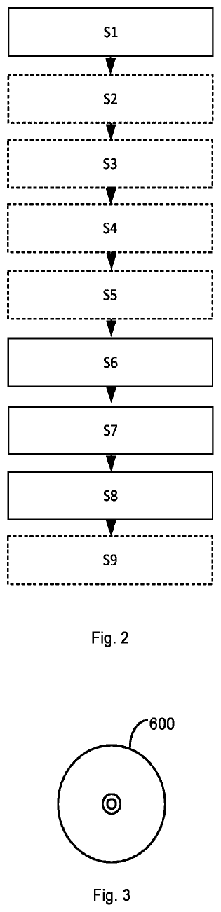

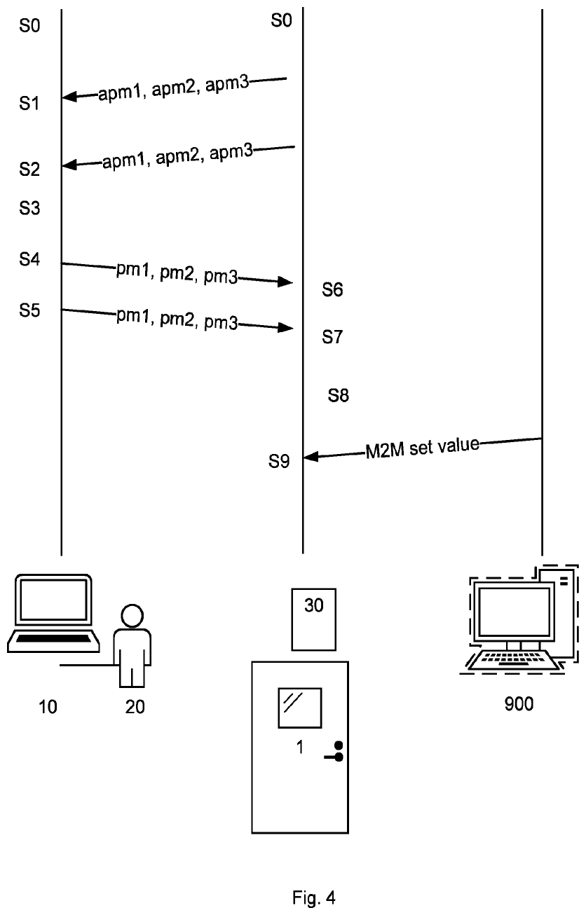

FIG. 2 illustrates a flow chart of the method steps according to the second aspect of the disclosure. Reference is also made to FIG. 4 that illustrates an example flow chart of the method steps in relation to the messaging between the door operator terminal 10, the door control unit 30 and the machine 900, according to some embodiments of the present disclosure.

The method comprising the step of S1 obtaining allowable parameter setting apm1,apm2,apm3 defining the possible parameters for operation of the door 1.

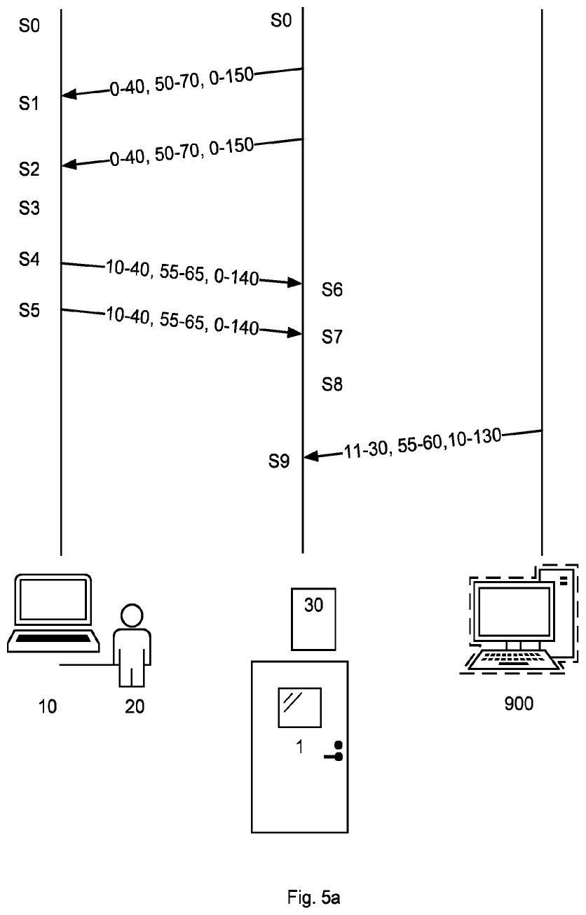

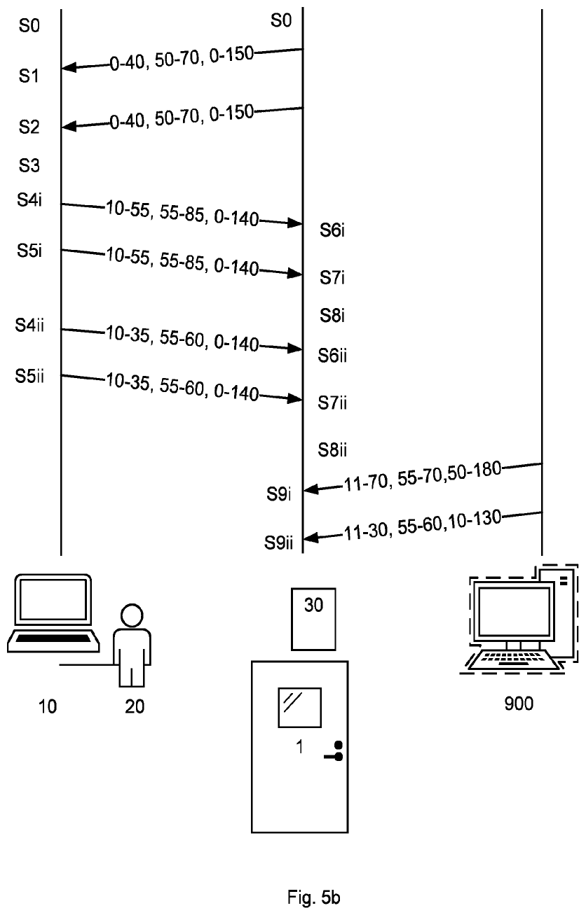

In the example in FIG. 4, the allowable parameter setting apm1,apm2,apm3 defining the possible parameters for operation of the door 1 is obtained by the door operator terminal 10 from the door control unit 30. In the example as illustrated in FIG. 4 the obtained allowable parameter setting apm1,apm2,apm3 defining the possible parameters for operation of the door 1. FIG. 5a illustrates an example flow chart of a successful update of parameter settings. In the example in FIG. 5a the allowable parameter setting apm1,apm2,apm3 defining the possible parameters for operation of the door 1 are different ranges for different parameters; 0-40, 50-70 and 0-150. In an example the first value relates to the opening time of the door, the second value relates to the closing speed of the door and the third value relates to the opening angle of the door 1.

The method further comprising the step of S6 receiving, at a door control unit 30, a first parameter settings message indicative of updated parameter settings pm1,pm2,pm3 related to the operation of the door 1, the step of S7 receiving, at the door control unit 30, a second parameter settings message indicative of updated parameter settings pm1,pm2,pm3 related to the operation of the door 1.

In the example in FIG. 5a, the first parameter settings message indicative of updated parameter settings pm1,pm2,pm3 related to the operation of the door 1 is received at the door control unit 30, and comprises the different ranges 10-40, 55-65 and 0-140. The second parameter settings message is also received at the door control unit 30 and the content of the second parameter settings message is identical to the fist second parameter settings message. The method further comprising the step of S8 determining if the parameter settings related to the operation of the door 1 is to be updated in view of the obtained allowable parameter setting apm1,apm2,apm3, in that in a determination that the first parameter settings message and the second parameter settings message are both indicative of the same updated parameter settings pm1,pm2,pm3, and allowable in view of the allowable parameter setting apm1,apm2,apm3, update, by the door control unit 30, the parameter setting pm1,pm2,pm3 related to the operation of the door 1.

In the example of FIG. 5a the first parameter settings message and the second parameter settings message are identical, and also the different ranges 10-40, 55-65 and 0 -140 are all within the allowable parameter setting apm1,apm2,apm3 0-40, 50-70 and 0-150, hence the parameter setting related to the operation of the door 1 will be updated accordingly.

The method further comprising that in a determination that the first parameter settings message and the second parameter settings message are indicative of different updated parameter settings or not allowable in view of the allowable parameter setting apm1,apm2,apm3, ignore updating the parameter settings related to the operation of the door 1.

FIG. 5b illustrates an example flow chart of a successful and unsuccessful update of parameter settings.

In particular, in the step S4i and S5i the first parameter settings message and the second parameter settings message are identical, however, two of the three different ranges 10-55, 55-85, 0-140 are out of the allowable parameter setting apm1,apm2,apm3 0-40, 50-70and 0-150, and hence the parameter settings related to the operation of the door 1 is not updated.

According to some embodiments in a determination that the first parameter settings message and the second parameter settings message are both indicative of the same updated parameter settings pm1, pm2, pm3, and at least one of plural parameter settings is allowable in view of the allowable parameter setting apm1, apm2, apm3, only update parameter setting that is allowable.

Hence in this example, update of all parameter setting apm1,apm2,apm3 was not successful.

In a further attempt to update the parameter settings, as illustrated in the step S4ii and S5ii, the first parameter settings message and the second parameter settings message are identical and the different ranges 10-35, 55-60 and 0 -140 are all within the allowable parameter setting apm1,apm2,apm3 0-40, 50-70 and 0-150, hence the parameter setting related to the operation of the door 1 will be updated accordingly.

Hence in the example, the update of all parameter setting apm1,apm2,apm3 was successful.

An advantage with the second aspect is that the parameter settings can be updated in a controlled and reliable way, to enable dynamic operation of the door 1 according to the updated parameter settings, in that the received updated parameter settings is an allowable parameter setting, but also in that the updated parameter settings are received twice, eliminating possible false update of the parameter settings due to a possible damaged message, by the verification of the received parameter settings of the first and second parameter settings message.

According to some embodiments the method further comprising the step of SO obtaining information indicative of allowable parameter setting apm1,apm2,apm3 defining the possible parameters for operation of the door 1 by receiving input from a user 20 via the user interface 400a,400b.

An advantage with this embodiment is that e.g. a person installing the door can input allowable parameter setting defining the possible parameters for operation of the door via the user interface 400a,400b in order to adapt the default values set when manufacturing the door for an operation of the door adapted to the environment where the door is installed.

According to some embodiments the method further comprising the step of S2 sending, from the door control unit 30 to a door operator terminal 10 an allowable parameter setting message indicative of allowable parameter setting apm1,apm2,apm3 defining the possible parameters for operation of the door 1, and the step of S3 enabling the door operator terminal 10 to only send allowable updated parameter settings from the door control unit 30 to the door operator terminal 10.

An advantage with this embodiment is that the door operator terminal becomes aware of the range of parameter settings that are possible in view of the allowable parameter setting, and by hindering the door operator terminal to send other parameter settings that are outside of the allowable parameter setting, minimizes the risk of that a false parameter setting is sent to the door control unit from the door operator terminal.

According to some embodiments the method further comprising the step of S4 sending, from the door operator terminal 10 to the door control unit 30, a first parameter settings message indicative of updated parameter settings pm1,pm2,pm3 related to the operation of the door 1, and the step of S5 sending, from the door operator terminal 10 to the door control unit 30, a second parameter settings message indicative of updated parameter settings pm1,pm2,pm3 related to the operation of the door 1.

An advantage with this embodiment is that the door operator terminal 10 is configured to send two separate messages in order to establish that the updated parameter settings as indicated in the first message, truly are correct by sending a second message with the same update parameter settings in order to enable that the desired updated parameter settings are correctly received at the door control unit 30.

According to some embodiments if the second parameter settings message is not received within a first predetermined threshold time period after receiving the first parameter settings message, ignore updating the parameter settings related to the operation of the door 1.

An advantage with this embodiment is that the parameter setting can only be updated in the case that the second parameter settings message is received within the first predetermined threshold time period after receiving the first parameter settings message, meaning that one parameter settings message is not sufficient enough for updating the parameter settings.

According to some embodiments the method further comprising the step of S9 receiving, at the door control unit 30, a machine-to-machine command setting message indicative of a set value for operating the door 1.

In the FIG. 4 the step of S9 is illustrated as the “M2M set value” sent from the machine 900 to the door control unit 30.

According to some embodiments in a determination that the set value is allowable in view of the current parameter setting apm1,apm2,apm3, allow operation of the door 1 according to the received machine-to-machine command setting message, and in a determination that the set value is not allowable in view of the current parameter setting apm1,apm2,apm3, ignore operation of the door 1 according to the received machine-to-machine command setting message.

An advantage with this embodiment is that one machine-to-machine command setting message generated and sent by a machine to the door control unit, in order to control the operation of the door, can be received and change the operation of the door according to the set value in the case that the received machine-to-machine command setting message is indicative of a set value that is an allowable value when comparing the set value with the allowable parameter setting.

In FIG. 5a, a successful machine-to-machine command setting message is illustrated, in that the set value 11-30, 55-60, 10-130 is allowable in view of the current parameter setting 10-40, 55-65, 0-140.

In FIG. 5b, one successful and one unsuccessful machine-to-machine command setting message are illustrated. In the step S9i the set value 11-70, 55-70, 50-180 is not allowable in view of the current parameter setting 10-35, 55-60, 0-140. However, in the step S9ii the set value 11-30, 55-60, 10-130 is allowable in view of the current parameter setting 10-35, 55-60, 0-140.

The third aspect of this disclosure shows a computer program product comprising a non-transitory computer readable medium, having thereon a computer program comprising program instructions, the computer program being loadable into the processing circuitry 102a,102b,102c and configured to cause execution of the method of the second aspect when the computer program is run by the processing circuitry 102a, 102b,102c.

The person skilled in the art realizes that the present disclosure is not limited to the preferred embodiments described above. The person skilled in the art further realizes that modifications and variations are possible within the scope of the appended claims.

Additionally, variations to the disclosed embodiments can be understood and effected by the skilled person in practicing the claimed disclosure, from a study of the drawings, the disclosure, and the appended claims.

1. A door control system (100) for safe configuration of the operation of a door (1), the system (100) comprises:
a door control unit (30) configured to operate the door (1) and configured to manage parameter settings related to the operation of the door (1);
a processing circuitry (102a, 102b,102c) operatively connected to the door control unit (30) configured to:
obtain information indicative of allowable parameter setting (apm1,apm2,apm3) defining the possible parameters for operation of the door (1);
receive, at the door control unit (30), a first parameter settings message indicative of updated parameter settings (pm1,pm2,pm3) related to the operation of the door (1);
receive, at the door control unit (30), a second parameter settings message indicative of updated parameter settings (pm1,pm2,pm3) related to the operation of the door (1);
determine if the parameter settings related to the operation of the door (1) is to be updated in view of the obtained allowable parameter setting (apm1,apm2,apm3), in that in a determination that the first parameter settings message and the second parameter settings message are both indicative of the same updated parameter settings (pm1,pm2,pm3), and allowable in view of the allowable parameter setting (apm1,apm2,apm3),
update, by the door control unit (30), the parameter settings (pm1,pm2,pm3) related to the operation of the door (1); and
in a determination that the first parameter settings message and the second parameter settings message are indicative of different updated parameter settings or not allowable in view of the allowable parameter setting (apm1,apm2,apm3),
ignore updating the parameter settings related to the operation of the door (1).

2. The door control system (100) according to claim 1, further comprises:
a user interface (400a,400b) configured to receive input if a user (20); wherein the user interface (400a, 400b) is operatively connected to the door control unit (30) and the processing circuitry (102a, 102b,102c), wherein processing circuitry (102a, 102b,102c) is further configured to:
-obtain information indicative of allowable parameter setting (apm1,apm2,apm3) defining the possible parameters for operation of the door (1) by receiving input from a user (20) via the user interface (400a,400b).

3. The door control system (100) according to claim 1, further comprises:
a door operator terminal (10) configured to be operated by a user (20) and configured to communicate with the door control unit (30); and wherein the door operator terminal (10) is operatively connected to the door control unit (30) and the processing circuitry (102a, 102b,102c).

4. The door control system (100) according to claim 3, wherein the processing circuitry (102a, 102b, 102c) is further configured to:
send, from the door control unit (30) to the door operator terminal (10) an allowable parameter settings message indicative of allowable parameter setting (apm1,apm2,apm3) defining the possible parameters for operation of the door (1); and
enable the door operator terminal (10) to only send allowable updated parameter settings from the door control unit (30) to the door operator terminal (10).

5. The door control system (100) according to claim 3, wherein processing circuitry (102a, 102b,102c) is further configured to:
send, from the door operator terminal (10) to the door control unit (30), a first parameter settings message indicative of updated parameter settings (pm1,pm2,pm3) related to the operation of the door (1); and
send, from the door operator terminal (10) to the door control unit (30), a second parameter settings message indicative of updated parameter settings (pm1,pm2,pm3) related to the operation of the door (1).

6. The door control system (100) according to claim 1, wherein the processing circuitry (102a, 102b,102c) is further configured to:
receive, at the door control unit (30), a machine-to-machine command setting message indicative of a set value for operating the door(1), and in a determination that the set value is allowable in view of the current parameter setting (pm1,pm2,pm3):
allow operation of the door (1) according to the received machine-to-machine command setting message; and
in a determination that the set value is not allowable in view of the current parameter setting (pm1,pm2,pm3):
ignore operation of the door (1) according to the received machine-to-machine command setting message.

7. The door control system (100) according to any of the preceding claim 1, wherein if the second parameter settings message is not received within a first predetermined threshold time period after receiving the first parameter settings message, ignore updating the parameter settings related to the operation of the door (1).

8. The door control system (100) according to claims claim 1, wherein if the second parameter settings message is received after a second predetermined threshold time period after receiving the first parameter settings message, ignore updating the parameter settings related to the operation of the door (1) and make the received second parameter settings message a first parameter settings message and await a further parameter settings message within the first predetermined threshold time period to be considered as a second parameter settings message.

9. A method for safe configuration of the operation of a door (1), the method comprising:
(S1) obtaining allowable parameter setting (apm 1,apm2,apm3) defining the possible parameters for operation of the door (1);
(S6) receiving, at a door control unit (30), a first parameter settings message indicative of updated parameter settings (pm1,pm2,pm3) related to the operation of the door (1);
(S7) receiving, at the door control unit (30), a second parameter settings message indicative of updated parameter settings (pm1,pm2,pm3) related to the operation of the door (1);
(S8) determining if the parameter settings related to the operation of the door (1) is to be updated in view of the obtained allowable parameter setting (apm1,apm2,apm3), in that in a determination that the first parameter settings message and the second parameter settings message are both indicative of the same updated parameter settings (pm1,pm2,pm3), and allowable in view of the allowable parameter setting (apm1,apm2,apm3), update, by the door control unit (30), the parameter setting (pm1,pm2,pm3) related to the operation of the door (1); and
in a determination that the first parameter settings message and the second parameter settings message are indicative of different updated parameter settings or not allowable in view of the allowable parameter setting (apm1,apm2,apm3), ignore updating the parameter settings related to the operation of the door (1)

10. The method according to claim 9 further comprising:
(SO) obtaining information indicative of allowable parameter setting (apm1,apm2,apm3) defining the possible parameters for operation of the door (1) by receiving input from a user (20) via the user interface (400a,400b).

11. The method according to 10 claim 9 further comprising:
(S2) sending, from the door control unit (30) to a door operator terminal (10) an allowable parameter setting message indicative of allowable parameter setting (apm 1,apm2,apm3) defining the possible parameters for operation of the door (1); and
(S3) enabling the door operator terminal (10) to only send allowable updated parameter settings from the door control unit (30) to the door operator terminal (10).

12. The method according to claim 9 further comprising:
(S4) sending, from the door operator terminal (10) to the door control unit (30), a first parameter settings message indicative of updated parameter settings (pm1,pm2,pm3) related to the operation of the door (1); and
(S5) sending, from the door operator terminal (10) to the door control unit (30), a second parameter settings message indicative of updated parameter settings (pm1,pm2,pm3) related to the operation of the door (1).

13. The method according to claim 9, wherein if the second parameter settings message is not received within a first predetermined threshold time period after receiving the first parameter settings message, ignore updating the parameter settings related to the operation of the door (1).

14. The method according to claim 9 further comprising:
(S9) receiving, at the door control unit (30), a machine-to-machine command setting message indicative of a set value for operating the door(1), and in a determination that the set value is allowable in view of the current parameter setting (pm1,pm2,pm3):
allow operation of the door (1) according to the received machine-to-machine command setting message; and
in a determination that the set value is not allowable in view of the current parameter setting (pm1,pm2,pm3):
ignore operation of the door (1) according to the received machine-to-machine command setting message.

15. A computer program product (600) comprising a non-transitory computer readable medium, having thereon a computer program comprising program instructions, the computer program being loadable into a processing circuitry (102a, 102b,102c) and configured to cause execution of the method according to claim 9 when the computer program is run by the processing circuitry (102a, 102b, 102c).
